(19) United States
(12) Patent Application Publication
(10) Pub. No.: US 2023/0002197 A1
(43) Pub. Date: Jan. 5, 2023

(54) DOOR FRAME OF AN ELEVATOR SYSTEM

(71) Applicant: Inventio AG, Hergiswil (CH)

(72) Inventors: Philipp Buchs, Adligenswil (CH); Paolo Ferrario, Thalwil (CH); Enrico Marinelli, Zug (CH)

(21) Appl. No.: 17/757,232

(22) PCT Filed: Nov. 27, 2020
(86) PCT No.: PCT/EP2020/083684

§ 371 Date: Jun. 13, 2022

(30) Foreign Application Priority Data
Dec. 20, 2019 (EP) 19218456.2

(51) Int. Cl. B66B 13/30; B66B 11/00

(52) U.S. Cl. CPC B66B 13/306; B66B 11/001

(57) ABSTRACT

A door frame of a shaft door is provided for an elevator system having an elevator shaft accessed through the shaft door. The door frame forms a chamber accommodating a control unit for the elevator system. The door frame has a side surface facing the elevator shaft, a first door frame element delimiting the chamber and a second door frame element delimiting the chamber. The first door frame element can be detached from the second door frame element by a movement of the first door frame element, from its closed position, in parallel with the side surface, to open the chamber. The invention also relates to an elevator system (2) comprising such a door frame (22).

### FIELD

The invention relates to a door frame having a chamber for accommodating a control unit of an elevator system.

### BACKGROUND

Elevator systems comprise an elevator car which can usually be moved vertically along an elevator shaft. The elevator car can thus be moved in such a way that it can be positioned at individual shaft doors such that access from the elevator car to the floor associated with the individual shaft door is provided. The control of the elevator system, in particular for the mobility of the elevator car is required. In addition, such a control unit can contain interfaces and input modules which are necessary for servicing the elevator system and for diagnostics.

This control unit can advantageously be arranged such that servicing of the elevator system or the control unit can be carried out easily. Therefore, it is advantageous to arrange the control unit in a door frame of such a shaft door. Such a door frame is usually formed by a door lintel and a door post formed on each side of the door opening. To accommodate the control unit, the interior of one of these two door posts can form a chamber which is delimited by side walls of the door post.

EP1518815 discloses such a door post which is formed having a chamber. A control unit is arranged in this chamber. The control unit itself is not visible when the elevator system is in normal operation. Access to the control unit is required for service or maintenance work. On the one hand, the control unit must be accessible for service work on the elevator system. The control unit must be visible in this state and it must be possible to carry out the activities required to service the elevator system, such as initializing travel commands, requesting status information or actuating switches. On the other hand, if more extensive maintenance work is required, such as the replacement of components of the control unit, an appropriately extended degree of accessibility must be ensured. The difference between service and maintenance work is that servicing requires limited access to the control unit and does not require a large amount of space. In contrast, parts may have to be replaced as part of the maintenance of the control unit, for which a correspondingly large access space is necessary.

The interior of the chamber and thus the control unit for carrying out service work can be accessed from the floor. A further opening in the door post is arranged such that maintenance can be carried out on the control unit from inside the elevator shaft. It is therefore necessary for the service technician to be in front of this opening to carry out maintenance of the control unit. This can be achieved by placing the roof of the elevator car directly below this opening so that the service technician can carry out this maintenance from the roof of the elevator car.

Thus, the disadvantage is that the elevator car has to be arranged in the elevator shaft in such a way that the roof of the elevator car can be used as a work platform for maintenance of the control unit.

### SUMMARY

The problem addressed by the invention is therefore that of providing a door frame which allows improved access to a control unit which can be arranged in the door frame.

The problem is solved by means of a door frame of an elevator system having an elevator shaft, the door frame forming a chamber for accommodating a control unit and forming a side surface facing the elevator shaft, the door frame having a first door frame element delimiting the chamber and a second door frame element delimiting the chamber, wherein the first door frame element can be detached from the second door frame element substantially by a movement of the first door frame element, from its closed position, in parallel with the side surface, and the chamber can thus be opened. The problem is also solved by means of an elevator system comprising such a door frame.

The elevator system preferably has a building wall, in which building wall a shaft door of the elevator system is formed. The side surface facing the elevator shaft is preferably formed in parallel with this building wall.

Such a door frame usually comprises a door lintel and two door posts, the door lintel being arranged above a door opening which is usually delimited laterally and at the top by the door frame. A first of these door posts is arranged to the side of the door opening, and a second of the two door posts is arranged on the other side of the door opening. Such a door post or door lintel usually has two walls which are arranged at an angle to one another and which face the floor, with one of these walls usually forming a direct closure of the door opening. In addition, the door lintel or door post has the side surface mentioned, which is arranged in parallel with the door opening, i.e. substantially in parallel with at least one door leaf closing the door opening.

The parallel of the side surface of the door frame that is in the closed state forms a part of the door frame that cannot be accessed from the floor when the shaft door is closed, since this side surface directly faces the elevator shaft. The side surface is not necessarily designed as a closed wall of the door frame, but optionally comprises only webs, profile elements or the like that stabilize the door frame or the corresponding door frame element. Optionally, the side surface can include a part of the second door frame element and a part of the first door frame element.

The invention is based on the knowledge that access to the mechanism for fixing the door frame elements which delimit the chamber is crucial in order to allow maintenance to be carried out on the control unit quickly and easily. Accordingly, if the control unit is arranged in a door post or door lintel of the car door, positioning the elevator car at the floor so that an interior of the elevator car can be accessed from this floor is a way of significantly simplifying maintenance. If, on the other hand, the control unit is arranged in the door post of the shaft door, it is preferably possible to carry out the maintenance of the control unit with the shaft door closed, irrespective of the position of the elevator car.

A prerequisite for this is, on the one hand, that the first door frame element to be removed for maintenance can be removed independently of the position of the elevator car that is movably arranged in the elevator shaft. On the other hand, it is necessary that this first door frame element to be removed or the opening in the door frame resulting from the removal of the first door frame element is designed to be sufficiently large for carrying out maintenance of the control unit.

In order to achieve removability of the first door frame element when the elevator car is present at the floor, for example, the removable first door frame element is thus proposed, which first door frame element can preferably be moved out of its closed position, i.e. its position closing the chamber, solely by a movement of the first door frame element directed in parallel with the above-mentioned side wall.

In a development of the door frame, the first door frame element has a fixing region parallel to the side surface and the second door frame element has a fixing region parallel to the side surface, and the fixing regions of the first door frame element and the second door frame element can be fixed directly to one another by means of a detachable fixing. By means of such a fixing, the first and the second door frame element can be fixed to one another directly adjacent to the interior of the elevator shaft. By detaching this fixing and removing the first door frame element in such a way that part of the side surface of the first door frame element that adjoins an interior of the elevator shaft can also be removed, the chamber containing or capable of containing the control unit can be accessed for the purpose of maintenance of the control unit.

A development of the fixing is formed by a screw connection. By means of such a screw connection, which interconnects the fixing regions of the first and the second door frame element in the closed position of the first door frame element, a connection which can be easily detached by the service or maintenance technician from inside the chamber is made possible.

In a development of the door frame, a slot-shaped open threaded pin receptacle is or can be arranged on a first of the first and second door frame elements and a threaded pin is or can be arranged on the second of the two door frame elements in such a way that the first element can be fixed to the second door frame element by means of a screw nut. Such a threaded pin can be fixed to the first or second door frame element or formed by a screw so that detachment of such a screw connection can take place preferably manually from the interior of the chamber containing the control unit. When the screw connection is loosened, the slot-shaped open threaded pin receptacle allows the first door frame element to be moved from its closed position without requiring a relative movement of the first and second door frame elements in the main orientation of the threaded pin.

The screw nut can be formed by a wing nut. The connection which can be detached in the interior of the chamber by means of a screw nut allows the first door frame element to be removed easily, since no tools are required to detach this fixing if the chamber can be accessed beforehand.

A main extension direction of the threaded pin preferably extends substantially perpendicularly to the side surface. This allows good access for detaching the screw nut in the interior of the chamber.

In a development of the door frame, the detachable fixing of the first door frame element to the second door frame element can be detached by reaching into an interior of the chamber. This detachability of the fixing makes it possible for the elevator car to be arranged directly at the door post of the shaft door or for the shaft door to be closed when the first door frame element is removed.

The door frame preferably comprises a further fixing option for fixing the first door frame element in its closed position. Alternatively, in addition to the detachable fixing of the first door frame element, a device for supporting the first door frame element on the second door frame element may be provided to ensure a secure hold of the first door frame element in its closed position.

A development of the door frame comprises a third door frame element which delimits the chamber and is designed in such a way that the chamber can be accessed when the third door frame element is in an open position for detaching the first door frame element from the second door frame element, with the chamber preferably being accessible for servicing the control unit when the third door frame element is in the open position. On the one hand, removing the third door frame element makes it possible to carry out service work on the control unit. On the other hand, the ability to reach into the interior of the chamber ensured in this way makes it possible to move the first door frame element out of the closed position for the purpose of maintenance of the control unit or to be able to detach the detachable fixing of the first door frame element from the second door frame element on the side surface. For this purpose, there is an opening behind the third door frame element so that, when the third door frame element is open, the chamber for accommodating the control unit can be accessed for a service or for detaching the first door frame element.

A development of the door frame comprises a door post, which door post is intended to be arranged on the side of the door opening enclosed by the door frame, and the door post comprises the door frame elements. As a result, it is possible for the control unit which can be placed in the chamber to be arranged in its vertical height in such a way that maintenance can be carried out in a simple manner for the service technician, for example without necessarily having to carry out maintenance from a ladder.

In a development of the door frame, the second door frame element is an integral part of the door post. Accordingly, the second door frame element is firmly fixed and cannot be removed for maintenance or servicing of the control unit.

In a development of the door frame, the first door frame element is formed by a corner element of the door frame. This means that the first door frame element preferably has an angled portion which is aligned in parallel with the side closure of the element and is preferably formed by an angle of 70° to 110°, preferably 90°, to form the corner element. Such an angled portion causes increased stability of the door frame element formed in this way such that the first door frame element does not have to have any additional reinforcements or reinforcement elements.

A development of the door frame is designed as a shaft door frame. In this way, maintenance of the control unit is made possible without there being a compelling need for the elevator system to be functional, i.e. for the elevator car to be in the movable state. Furthermore, it is advantageous that maintenance can be carried out entirely from the floor by means of such a door frame, preferably with the shaft door completely closed, i.e. independently of the position of the elevator car within the elevator shaft.

In a development of the door frame, the side surface facing the elevator shaft comprises a part of the first door frame element and a part of the second door frame element. This ensures that the accessibility of the control unit for maintenance purposes is as great as possible. The reason for this is that the gap between the open door post or open door lintel that can be provided with the control unit and the component arranged directly thereon, for example between the shaft door post that can be provided with the control unit and the car door post that can be arranged next to this shaft door post, can be used as a space for maintenance.

In a development of the door frame, the third door frame element is fixed in its closed position to the first door frame element. This allows for a simple design of the devices for fixing the first or the third door frame element in their closed position.

### DESCRIPTION OF THE DRAWINGS

The invention is explained in greater detail below with reference to drawings, in which:

FIG. 1 shows an elevator system having a plurality of shaft doors;

FIG. 2 shows one of the shaft doors having a door frame;

FIG. 3 shows a door post of the shaft door with an elevator car positioned at this shaft door in cross section; and

FIG. 4 shows a screw connection connecting the first and the second door frame element according to FIG. 3 in detail.

### DETAILED DESCRIPTION

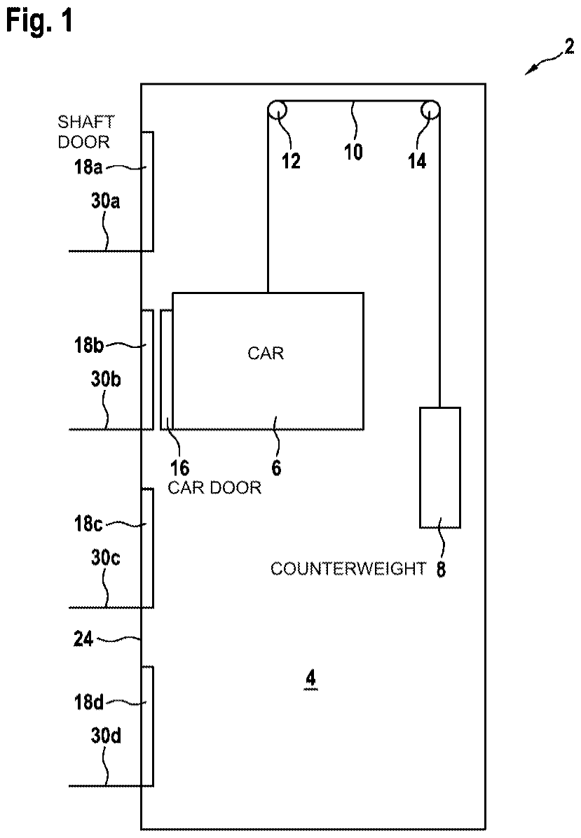

FIG. 1 shows an elevator system 2. The elevator system 2 is arranged in an elevator shaft 4. The elevator system 2 comprises an elevator car 6 which can be moved along the elevator shaft 4, a counterweight 8 which can be moved in the opposite direction to the elevator car 6, and a support element 10 which connects the elevator car 6 and the counterweight 8. The support element 10 can be guided over deflection rollers 12, 14, and one of these deflection rollers 12, 14 can be designed as a drive roller of a drive unit of the elevator system 2.

The elevator shaft 4 has a plurality of shaft door openings which are usually arranged vertically one above the other, with the shaft door openings allowing access to the interior of the elevator shaft at floors 30a, 30b, 30c, 30d. The shaft door openings are formed in a building wall 24.

A shaft door 18a, 18b, 18c, 18d which can be associated with the floor 30a, 30b, 30c, 30d is positioned at each of these shaft door openings. The elevator car 6 has a car door 16. This car door 16 or the elevator car 6 can be positioned at one of the shaft doors 18a, 18b, 18c, 18d by moving the elevator car 6 in the elevator shaft 4.

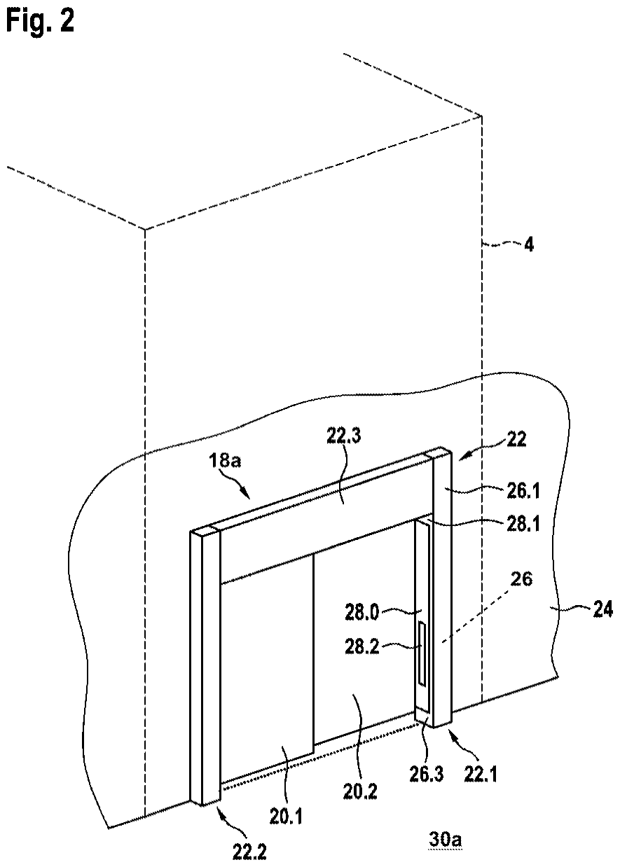

FIG. 2 shows a shaft door 18a positioned at one of these floors 30a as an example for any of the other shaft doors 18b, 18c, 18d. The shaft door 18a substantially comprises a door frame 22 and at least one door leaf 20.1, 20.2, and the door opening can be closed and/or opened by means of the at least one door leaf 20.1, 20.2. The door opening is formed in a building wall 24, with this building wall 24 usually delimiting the elevator shaft 4 on one side. The door frame 22 comprises two door posts 22.1, 22.2 and a door lintel 22.3. A first of the two door posts 22.1 is arranged on one side of the door opening, and the second of the door posts 22.2 is arranged on the other side of the door opening. The door lintel 22.3 is arranged above the door opening.

One of the two door posts 22.1, 22.2 or the door lintel 22.3 has a chamber for accommodating a control unit. As an example, FIG. 2 shows that the chamber 26 is arranged within one of the door posts 22.1. The door post 22.1 has walls 26.1, 26.3 which delimit the chamber 26.

The door post 22.1 has a first and a second door frame element 28.0, 28.1 which delimits the chamber 26, and the second door frame element 28.1 can be formed by a plurality of door frame elements. The second door frame element 28.1 is formed across a corner, according to which FIG. 2 shows that a part of the second door frame element 28.1 is part of both a first and a second of these walls 26.1, 26.3. The wall 26.3 directly delimiting the door opening, i.e. facing the door post 22.2 arranged on the other side of the door opening, is arranged at a right angle to the wall 26.1 in the embodiment shown. The wall 26.3 facing the door opening thus forms a direct closure of the door opening. To carry out maintenance work, the first door frame element 28.0 is detachably fixed to the second door frame element 28.1.

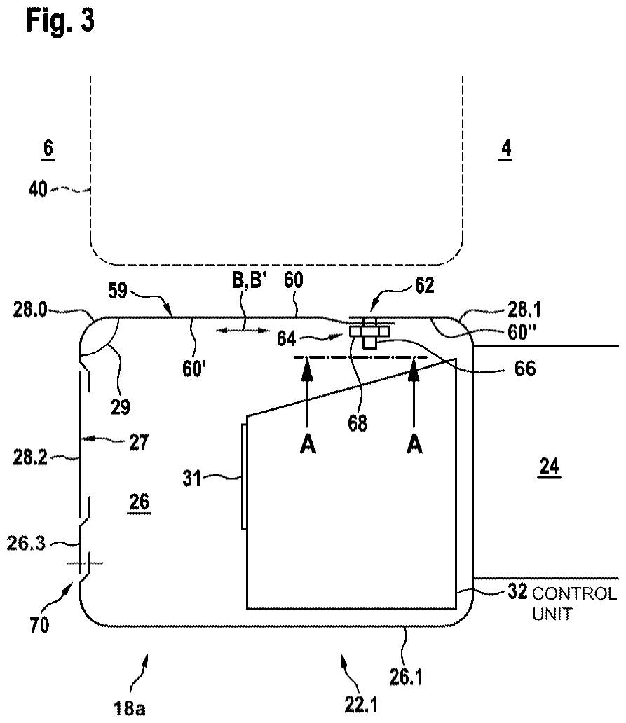

In addition, the door post 22.1 can comprise a third door frame element 28.2 delimiting the chamber 26. The third door frame element 28.2 is designed as a service opening, so that the control unit 32 (see FIG. 3) can be accessed through an opening in the door post 22.1 by moving the third door frame element 28.2 into its open position for carrying out service work to be carried out on the control unit 32. For example, the control unit 32 can comprise an input field 31 (see FIG. 3) for entering commands for this purpose. Consequently, the third door frame element 28.2 can have significantly smaller dimensions than the first door frame element 28.0 and can be limited in the extent of its length or width by the first door frame element 28.0.

The door frame elements 28.0, 28.2 shown in FIG. 2, which can be removed for maintenance or servicing of the control unit 32, are shown in their closed position. This means that the chamber arranged in the door post 22.1 and thus the control unit located therein cannot be accessed either for the purpose of maintenance or for the purpose of servicing the control unit. It is shown by way of example that the third door frame element 28.2 is fixed in its closed position directly to the first door frame element 28.0.

FIG. 3 shows the door post 22.1 shown in FIG. 2 and comprising the chamber 26 in cross section, the elevator car 6 being positioned at the shaft door 18a with which the door post 22.1 is associated. The control unit 32 is arranged within the chamber 26. The door post 22.1 has a side surface 60 which directly faces the elevator shaft 4. This means that the side surface 60 is arranged substantially in parallel with the building wall 24, in which building wall 24 the shaft door 18a is formed. Optionally, this side surface 60 comprises only at least one web 59 designed to fasten the first door frame element 28.0 to the second door frame element 28.1, and so the door post 22.1 forming the chamber 26 toward the elevator shaft 4 generally does not have to be closed.

The first door frame element 28.0 has a fixing region 60′ parallel to the side surface 60. The second door frame element 28.1 has a fixing region 60″ parallel to the side surface 60. The first door frame element 28.0 and the second door frame element 28.1 can be fixed directly to one another, preferably by means of at least one screw connection 62.

The screw connection 62 has a threaded pin 66 and a nut 68, with the main extension direction of the threaded pin 66 preferably being aligned substantially perpendicularly to the side surface 60. According to FIG. 3, the threaded pin 66 can be fixed to the fixing region 60″ of the second door frame element 28.1, for example. The fixing region 60′ of the first door frame element 28.0 has a slot-shaped open threaded pin receptacle so that, when the screw connection 62 is not fixed, the first door frame element 28.0 can be moved into its closed position or out of its closed position by means of a movement B, B′ directed in parallel with the side surface 60. The first door frame element 28.0 can be fixed to or detached from the second door frame element 28.1 by means of a nut 68, preferably a wing nut that can be fixed or detached by hand.

Alternatively, the threaded pin 66 can be fixed to the fixing region 60′ of the first door frame element 28.0 and the second door frame element 28.1 can correspondingly have the slot-shaped open threaded pin receptacle.

In addition, the first door frame element 28.0 can be fixed to the second door frame element 28.1 by means of a further fixing option 70, preferably a second screw connection, which is shown only schematically here and can be accessed directly from the floor. The fixing option 70 allows the first door frame element 28.0 to be fixed to the second door frame element 28.1 in the region of the wall 26.1 which delimits the chamber 26 and faces the floor or the wall 26.3 which delimits the chamber 26 and faces the floor.

The decisive factor here is that the fixing option 70 is designed so as to allow the movement B, B′ when the fixing of the first door frame element 28.0 is detached from the second door frame element 28.1 for removal of the first door frame element 28.1. Consequently, the fixing option 70 can be designed in the same way as the detachable fixing designed as a screw connection 62, for example, with it being possible for a pin, preferably a threaded pin, of the fixing option 70 to be aligned perpendicularly to the threaded pin 66 of the screw connection 62. The pin of the fixing option 70 can be designed without a thread so that, in this way, the fixing option 70 can be designed simply as a stop for the first door frame element 28.0 on the second door frame element 28.1.

An opening 27 is formed behind the third door frame element 28.2 arranged in its closed position, which opening 27 allows access for the purpose of servicing the control unit 32 when the third door frame element 28.2 is arranged in its open position. For example, the third door frame element 28.2 is fixed exclusively to the first door frame element 28.0 and can be arranged on the first door frame element 28.0 such that it can be removed or pivoted by means of a hinge. Alternatively or additionally, the third door frame element 28.2 can be locked to further components of the door frame 22 by means of a triangular key.

When the opening 27 is cleared, in addition to service activities on the control unit 32, both the fixing option 70 and the screw connection 62 can be detached by reaching into the chamber 26. In this way, the first door frame element 28.0 can be removed from the second door frame element 28.1 for the purpose of maintenance of the control unit 32 when a door post 40 of the car door 16 belonging to the elevator car 6 is arranged directly at the door post 22.1 having the chamber 26, i.e. the elevator car 6 is positioned at this floor 18a.

The removable first door frame element 28.0 is preferably designed as a corner element. The angled portion 29 shown in FIG. 3 leading to the formation of the corner element has a right angle. If necessary, the angle of the angled portion 29 can be configured differently from 90° in order to allow a different cross section of the door post 22.1 in accordance with customer-specific requirements.

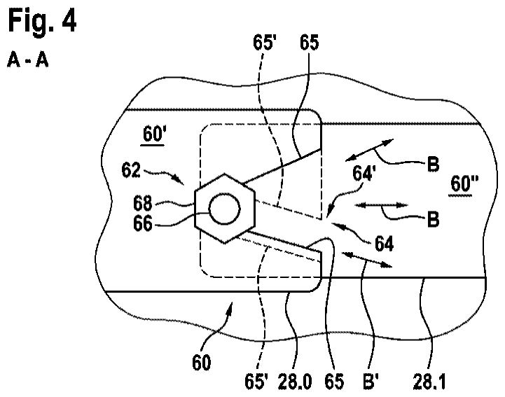

FIG. 4 shows the fixing region 60′ of the first door frame element 28.0 designed as a web parallel to the shaft wall (not shown) and the fixing region 60″ of the second door frame element 28.1 designed as a web parallel to the shaft wall (not shown) and the screw connection 62 connecting these fixing regions 60′, 60″ according to a detail A-A of FIG. 3. These fixing regions 60′, 60″ which are formed in parallel with the shaft wall form e.g. the side surface 60 of the door post 22.1 or the door frame 22 that faces the elevator shaft.

By detaching or loosening the previously fixed pin 66 and nut 68, a movement B, B′ of the first door frame element 28.0 in parallel with the side surface 60 is made possible in such a way that the threaded pin 66 can be displaced along the slot-shaped open threaded pin receptacle 64, 64′ according to exemplary movements B, B′. The slot-shaped open threaded pin receptacle 64, 64′ can be designed in different ways. The slot-shaped open threaded pin receptacle 64, 64′ has lateral guides 65, 65′ in order to guide the first door frame element 28.0 into its closed position by means of a movement B, B′.

In a first variant, the slot-shaped open threaded pin receptacle 64 can be V-shaped so that the first door frame element 28.0 can be pushed in from the direction of the door opening enclosed by the door frame 22, in parallel with the side surface 60, both obliquely from above and obliquely from below by means of the movement B shown. Accordingly, the distance between the lateral guides 65 decreases in the direction in which the first door frame element 28.0 is pushed into its closed position. The slot-shaped open threaded pin receptacle 64 designed in this way thus assumes the function of a catch for the first door frame element 28.0, which does not necessarily have to be placed precisely on the second door frame element 28.1.

In a second variant, the lateral guides 65′ of the slot-shaped open threaded pin receptacle 64′, shown in dashed lines, extend in parallel with one another, but not horizontally, so that the first door frame element 28.0 can be pushed in exclusively obliquely downward for example in the direction of its closed position by means of the movement B′ shown, so that gravity facilitates the transfer of the first door frame element 28.0 into its closed position.

In a third variant (not shown) the lateral guides of the slot-shaped open threaded pin receptacle can extend in parallel with one another and horizontally. In this way, the first door frame element 28.0 can be displaced into its closed position by means of a horizontal movement extending in parallel with the side surface 60.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A door frame of an elevator system having an elevator shaft, the door frame forming a chamber for accommodating a control unit and having a side surface facing the elevator shaft, the door frame comprising:
a first door frame element delimiting the chamber;
a second door frame element delimiting the chamber and being connected to the first door frame; and
wherein the first door frame element is detachable from the second door frame element by moving the first door frame element from a closed position preventing access to the chamber, where the first door frame element is parallel to the side surface, to an open position thereby providing access to the chamber.

17. The door frame according to claim 16 wherein the first door frame element has a first fixing region parallel to the side surface and the second door frame element has a second fixing region parallel to the side surface, wherein the first and second fixing regions are fixed directly to one another by a detachable fixing connection such that the first and second door frame elements are fixed to one another by the detachable fixing connection directly adjacent to an interior of the elevator shaft.

18. The door frame according to claim 17 wherein the detachable fixing connection is a screw connection.

19. The door frame according to claim 18 including a slot-shaped open receptacle is arranged on one of the first and second door frame elements and screw connection includes a threaded pin arranged on another of the first and second door frame elements such that the first door frame element is fixedly connected to the second door frame element by the threaded pin received in the receptacle and secured by a nut.

20. The door frame according to claim 19 wherein the nut is a wing nut.

21. The door frame according to claim 19 wherein a main extension direction of the threaded pin extends perpendicular to the side surface.

22. The door frame according to claim 17 wherein the detachable fixing connection arranged to be detached only by access to an interior of the chamber.

23. The door frame according to claim 16 including a third door frame element that delimits the chamber and provides access to the chamber when the third door frame element is in an open position for detaching the first door frame element from the second door frame element, wherein the chamber is accessible for servicing a control unit in the chamber when the third door frame element is in the open position.

24. The door frame according to claim 23 wherein the third door frame element is fixed in a closed position to the first door frame element.

25. The door frame according to claim 23 including a door post adapted to be arranged on a side of a door opening when the door frame is positioned at the door opening, the door post including the first, second and third door frame elements.

26. The door frame according to claim 16 including a door post adapted to be arranged on a side of a door opening when the door frame is positioned at the door opening, the door post including the first and second door frame elements.

27. The door frame according to claim 26 wherein the second door frame element is an integral part of the door post.

28. The door frame according to claim 16 wherein the first door frame element is formed by a corner element of the door frame.

29. The door frame according to claim 16 wherein the door frame is an shaft door frame in the elevator system.

30. The door frame according to claim 16 wherein the side surface facing the elevator shaft is a part of the first door frame element and a part of the second door frame element.

31. An elevator system comprising:
an elevator shaft having a shaft door opening; and
the door frame according to claim 16 arranged at the shaft door opening.
